(19) United States
(12) Patent Application Publication
(10) Pub. No.: US 2026/0138324 A1
(43) Pub. Date: May 21, 2026

(54) FILM FORMING APPARATUS, FILM FORMING METHOD, AND ARTICLE MANUFACTURING METHOD

(71) Applicant: CANON KABUSHIKI KAISHA, Tokyo (JP)

(72) Inventor: KUNIHIKO ASADA, Tochigi (JP)

(21) Appl. No.: 19/389,550

(22) Filed: Nov. 14, 2025

(30) Foreign Application Priority Data
Nov. 19, 2024 (JP) 2024-201759

(51) Int. Cl. B29C 59/02; B29C 33/72; B29C 35/08; B29C 59/00; B29L 7/00

(52) U.S. Cl. CPC B29C 59/02; B29C 33/72; B29C 35/08; B29C 59/002; B29L 2007/008

(57) ABSTRACT

A film forming apparatus that forms a film by bringing a curable composition on a substrate and a mold into contact with each other and curing the curable composition, includes: a substrate holder configured to hold the substrate; a mold operating mechanism that includes a mold holder configured to hold the mold and is configured to place the mold on a curable composition on the substrate; and a cleaner configured to clean an upper surface of the mold while the mold is placed on the curable composition on the substrate and the mold holder is separated from the mold.

### BACKGROUND

### Field of the Technology

The present disclosure relates to a film forming apparatus, a film forming method, and an article manufacturing method.

### Description of the Related Art

There is available a film forming apparatus that forms a film made of a cured product of a curable composition on a substrate by curing the curable composition while a mold is placed on the substrate through the curable composition. For example, Japanese Patent Laid-Open No. 2022-92347 discloses a planarization apparatus that forms a planarized film on a substrate by curing a curable composition while a mold is placed on the substrate through the curable composition. More specifically, in this planarization apparatus, after a head driver brings a mold into contact with a curable composition on a substrate held by a substrate holder, a mold holder is separated from the mold, and the substrate holder holding the substrate is moved to an exposing device. Subsequently, the planarization apparatus cures the curable composition at the exposing device and then moves the substrate holder to below the head driver. The head driver then separates the mold from the cured product of the curable composition on the substrate.

In the above film forming apparatus, for example, the upper surface of the mold can be charged when the mold holder is separated from the mold after the head driver brings the mold into contact with the curable composition on the substrate held by the substrate holder. With this charging, foreign substances can be attracted to adhere to the upper surface of the mold. If foreign substances adhere to the upper surface of the mold, the mold holder can fail to hold the mold.

### SUMMARY

The present disclosure provides a technique advantageous in preventing foreign substances from adhering to the upper surface of a mold.

The present disclosure includes a film forming apparatus that forms a film by bringing a curable composition on a substrate and a mold into contact with each other and curing the curable composition, the apparatus comprising: a substrate holder configured to hold the substrate; a mold operating mechanism that includes a mold holder configured to hold the mold and is configured to place the mold on a curable composition on the substrate; and a cleaner configured to clean an upper surface of the mold while the mold is placed on the curable composition on the substrate and the mold holder is separated from the mold.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view schematically showing the arrangement and operation of a film forming apparatus according to one embodiment;

FIG. 2 is a view schematically showing the arrangement and operation of the film forming apparatus according to one embodiment;

FIG. 3 is a view schematically showing the arrangement and operation of the film forming apparatus according to one embodiment;

FIG. 4 is a view schematically showing the arrangement and operation of the film forming apparatus according to one embodiment;

FIG. 5 is a view schematically showing the arrangement and operation of the film forming apparatus according to one embodiment;

FIGS. 6A to 6C are views for schematically explaining a procedure for film forming processing performed by the film forming apparatus; and

FIG. 7 is a flowchart showing a procedure for film forming processing performed by the film forming apparatus.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the following description and accompanying drawings, the shape of each constituent element and the positional relationships between a plurality of constituent elements will be described in accordance with an XYZ coordinate system. In the XYZ coordinate system, an XY plane can be a horizontal plane. In addition, the direction in which gravitational force acts on a mold and a substrate is the Z direction. Directions parallel to the X-axis, the Y-axis, and the Z-axis of the XYZ coordinate system are the X direction, the Y direction, and the Z direction, respectively. Rotations about the X-axis, the Y-axis, and the Z-axis are respectively represented by θX, θY, and θZ. Control or driving with respect to the X-axis, the Y-axis, and the Z-axis respectively mean control or driving with respect to a direction parallel to the X-axis, a direction parallel to the Y-axis, and a direction parallel to the Z-axis. In addition, control or driving with respect to the θX-axis, the θY-axis, and the θZ-axis respectively mean control or driving with respect to rotation about an axis parallel to the X-axis, rotation about an axis parallel to the Y-axis, and rotation about an axis parallel to the Z-axis. Positions are information that can be specified based on X-axis, Y-axis, and Z-axis coordinates, and postures are information that can be specified by θX-axis, θY-axis, and θZ-axis values. Alignment means control of a position and/or posture.

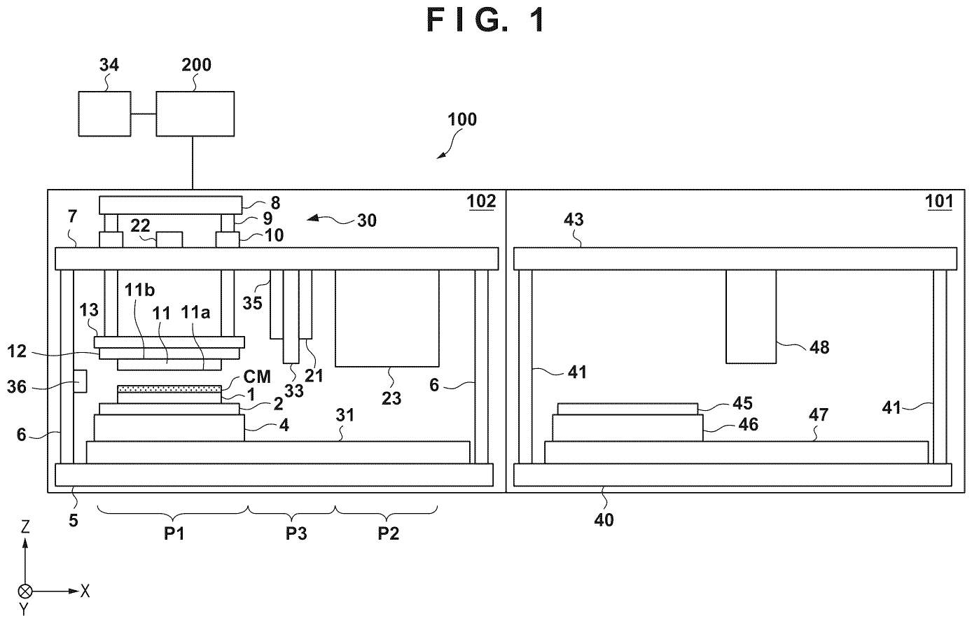

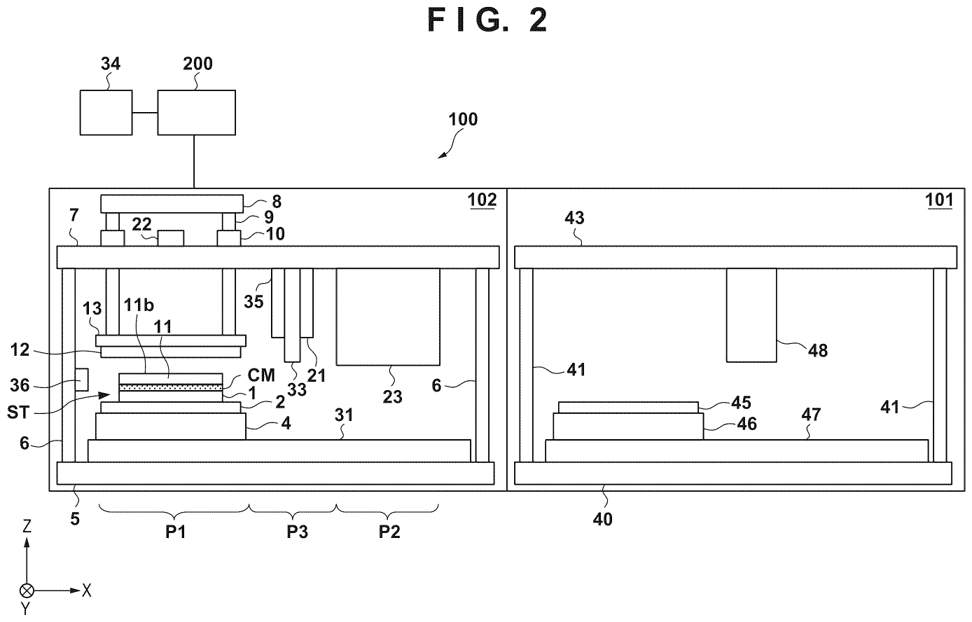

FIGS. 1 to 5 schematically show an example of the arrangement of a film forming apparatus 100 according to one embodiment. FIGS. 1 to 5 respectively show different states of the film forming apparatus 100 according to one embodiment. The film forming apparatus 100 can be configured to form a film made of a cured product CP of a curable composition CM by bringing a mold 11 into contact with the curable composition CM on a substrate 1 and curing the curable composition CM. The mold 11 can have a first surface (lower surface) 11a and a second surface (upper surface) 11b. As described above, in the film forming apparatus 100 according to one embodiment, the first surface (lower surface) 11a is located in the-Z direction with respect to the second surface (upper surface) 11b. The first surface 11a is a surface that comes into contact with the curable composition CM and can be, for example, a flat surface but may have a pattern. If the first surface 11a is a flat surface, the film made of the cured product CP is understood as a planarized film. The film forming apparatus 100 can be understood as a planarization apparatus.

The film forming apparatus 100 can include a first processing device 101 and a second processing device 102. The film forming apparatus 100 can include a substrate transfer mechanism (not shown) that transfers the substrate 1 and a mold transfer mechanism (not shown) that transfers the mold 11. The film forming apparatus 100 can also include an interface device 34 and a controller 200.

The first processing device 101 can execute an application step of applying the curable composition CM on the substrate 1. The second processing device 102 can execute a film forming step of forming a film on the substrate 1 having undergone the application step. The film forming step can include the first operation step of forming a multilayer structure ST composed of the substrate 1, the curable composition CM, and the mold 11 by placing the mold 11 held by a mold holder 12 on the curable composition CM on the substrate 1 and then separating the mold holder 12 from the mold 11. The film forming step can also include a curing step of curing the curable composition CM by applying curing energy CE to the curable composition CM of the multilayer structure ST after the first operation step and a separation step of separating the mold 11 from the multilayer structure ST after the curing step.

The curable composition CM is a composition that is cured by receiving the curing energy CE. As the curing energy CE, an electromagnetic wave, heat, or the like can be used. The electromagnetic wave can be light selected from the wavelength range of 10 nm (inclusive) to 1 mm (inclusive), for example, infrared light, a visible light beam, ultraviolet light, or the like. The curable composition CM may be understood as a composition cured by light irradiation or a composition cured by heating. A photo-curable composition cured by light may contain a polymerizable compound and a photopolymerization initiator and may contain a nonpolymerizable compound or a solvent, as needed. The nonpolymerizable compound is at least one material selected from the group consisting of a sensitizer, a hydrogen donor, an internal mold release agent, a surfactant, an antioxidant, and a polymer component. A curable composition may be applied onto the substrate in a film shape by a spin coater or a slit coater. Alternatively, the curable composition CM may be placed onto the substrate in a droplet shape or in an island or film shape formed by connecting a plurality of droplets using a liquid injection head. The viscosity (the viscosity at 25° C.) of the curable composition is, for example, 1 mPa·s (inclusive) to 100 mPa·s (inclusive). The curable composition CM can be a monomer such as acrylate or methacrylate.

Although the substrate 1 is, for example, a silicon wafer as a typical base material, the present disclosure is not limited to this. The substrate 1 can be arbitrarily selected from the group consisting of substrates for semiconductor devices, such as aluminum, a titanium-tungsten alloy, an aluminum-silicon alloy, an aluminum-copper-silicon alloy, silicon oxide, and silicon nitride. As the substrate 1, a substrate may be used, whose adhesiveness with respect to a curable composition is improved by forming an adhesive layer by a surface treatment such as silane coupling treatment, silazane treatment, or organic thin film formation. The substrate 1 typically has a circular shape having a diameter of 300 mm, but the present disclosure is not limited to this.

If light is used as the curing energy CE, the mold 11 is made of a material that transmits the light. The mold 11 is made of, for example, at least one of glass, quartz, light transmissive resin such as polymethylmethacrylate (PMMA) or polycarbonate resin, a transparent metal deposited film, a flexible film such as a polydimethylsiloxane film, a photo-curable film, and a metal film. The mold 11 preferably has the same size and shape (for example, a circular shape having a diameter of 300 mm) as those of the substrate 1. However, the present disclosure is not limited to this. For example, the thickness of the mold 11 can be equal to or more than 0.25 mm to less than 2 mm.

The first processing device 101 can include, for example, a base portion 40, a plurality of support pillars 41, a top plate 43, a substrate holder 45, a substrate stage 46, a substrate stage driver 47, and a dispenser 48. The base portion 40 can support the top plate 43 through the plurality of support pillars 41 as well as supporting the substrate stage 46 and the substrate stage driver 47. The top plate 43 can support the dispenser 48. The substrate holder 45 includes a chuck such as a vacuum chuck or electrostatic chuck and supports the substrate 1 with the chuck. The substrate stage 46 is supported by the base portion 40 and holds the substrate holder 45. The substrate stage 46 can be driven in the X-axis direction and the Y-axis direction to position the substrate 1 held by the substrate holder 45 to a target position. The substrate stage driver 47 includes, for example, a linear motor and/or an air cylinder and can drive the substrate stage 46 in at least the X-axis direction and the Y-axis direction. The substrate stage driver 47 may include a rotating mechanism and drive the substrate holder 45 with respect to the θZ-axis. The substrate stage driver 47 may have a function of driving the substrate stage 46 with respect to more axes (for example, six axes).

The dispenser 48 can be configured to apply or place the curable composition CM on the substrate 1 held by the substrate holder 45. For example, the dispenser 48 can apply or place a plurality of droplets of the curable composition CM on the substrate 1 by discharging the droplets of the curable composition CM while the substrate stage driver 47 drives the substrate 1. The dispenser 48 can have, for example, one or a plurality of discharge ports (nozzles) for discharging the curable composition CM. The dispenser 48 can supply curable composition droplets each having a micro volume (for example, 1 picolitre) on the substrate 1 by, for example, a piezojet or microsolenoid scheme. For example, the dispenser 48 can have 100 or more discharge ports. Such discharge ports are arranged, for example, in one or a plurality of lines.

The second processing device 102 can include, for example, a base portion 5, a plurality of support pillars 6, a top plate 7, a substrate holder 2, a substrate stage 4, and a substrate driving mechanism 31. The substrate holder 2 includes a chuck such as a vacuum chuck or electrostatic chuck and supports the substrate 1 with the chuck. The substrate stage 4 is supported by the base portion 5 and holds the substrate holder 2. The substrate stage 4 can be driven in the X-axis direction and the Y-axis direction to position the substrate 1 held by the substrate holder 2 to a target position. The substrate driving mechanism 31 includes, for example, a linear motor and/or an air cylinder and drives the substrate stage 4 in at least the X-axis direction and the Y-axis direction. The substrate driving mechanism 31 may include a rotating mechanism and drive the substrate holder 2 with respect to the θZ-axis. The substrate driving mechanism 31 may have a function of driving the substrate stage 4 with respect to more axes (for example, six axes).

The second processing device 102 can also include a mold operating mechanism 30. The mold operating mechanism 30 can include, for example, the mold holder 12 that holds the mold 11 and operate so as to place the mold 11 on the curable composition CM on the substrate 1. In addition, the mold operating mechanism 30 can separate the mold holder 12 from the mold 11 after placing the mold 11 on the curable composition CM on the substrate 1. The mold operating mechanism 30 can also separate the mold 11 from the cured product CP of the curable composition CM on the substrate 1. The mold operating mechanism 30 can include a guide bar plate 8, a guide bar 9, a head driver 10, the mold holder 12, and a head 13.

The mold holder 12 includes a chuck such as a vacuum chuck or electrostatic chuck and supports the mold 11 with the chuck. The head 13 holds and drives the mold holder 12. The head driver 10 drives the mold holder 12 by driving the head 13, thereby driving the mold 11. The head driver 10 can be configured to drive the mold 11 with respect to a plurality of axes.

The guide bar 9 is placed so as to extend through the top plate 7. One end of the guide bar 9 can be fixed to the guide bar plate 8, and the other end can be fixed to the head 13. The head driver 10 can drive the head 13 in the Z-axis direction by driving the guide bar 9. This makes it possible to bring the mold 11 held by the mold holder 12 into contact with the curable composition CM on the substrate 1 and to separate the mold 11 from the cured product CP of the curable composition CM on the substrate 1. The head driver 10 may include a mechanism for driving the head 13 with respect to axes other than the Z-axis. Alternatively, the head driver 10 can include a mechanism for driving the head 13 with respect to a plurality of axes (for example, three axes including the θX-axis, θY-axis, and the Z-axis or six axes including the X-axis, the Y-axis, the Z-axis, the θX-axis, the θY-axis, and the θZ-axis).

The second processing device 102 can also include an off-axis alignment (OA) scope 21, an alignment scope 22, a curing device 23, a cleaner 33, and a detector 35. The alignment scope 22 can include an optical system and an image capturing system which are used to observe a reference mark provided on the substrate stage 4 and an alignment mark provided on the mold 11. The alignment scope 22 can be used to measure the relative position between a reference mark provided on the substrate stage 4 and an alignment mark provided on the mold 11 and perform alignment for correcting the positional shift of the mold 11. The detector 35 can be used to detect the position of a reference such as a notch or orientation flat of the substrate 1 held by the substrate holder 2. More specifically, the detector 35 can be an optical sensor that detects the outer profile of the substrate 1, a camera that obtains the shape of the substrate 1, or the like.

The curing device 23 cures the curable composition CM by applying the curing energy CE (for example, light such as UV light) to the curable composition CM of the multilayer structure ST. This makes it possible to form a film made of the cured product CP of the curable composition CM. In this case, the mold operating mechanism 30 can be placed at a first position P1, and the curing device 23 can be placed at a second position P2 spaced away from the first position P1. The substrate holder 2 (the substrate stage 4) can be configured to be movable between a plurality of positions including the first position P1 and the second position P2. The mold operating mechanism 30 can operate the mold 11 so as to separate it from the multilayer structure ST held by the substrate holder 2 that has moved from the second position P2 to the first position P1.

The OA scope 21 is supported by the top plate 7. The OA scope 21 can be used for the global alignment processing of detecting alignment marks provided in a plurality of shot regions of the substrate 1 and determining the positions of the plurality of shot regions. It is possible to perform relative alignment between the mold 11 and the substrate 1 by obtaining the positional relationship between the mold 11 and the substrate stage 4 using the alignment scope 22 and obtaining the positional relationship between the substrate stage 4 and the substrate 1 using the OA scope 21.

The cleaner 33 can be configured and placed so as to clean the upper surface 11 b (the surface held by the mold holder 12) of the mold 11 while the mold holder 12 is separated from the mold 11. The meaning of cleaning is broadly interpreted and includes, for example, removing foreign substances such as particles from a cleaning target object (in this case, the upper surface 11b of the mold 11) and removing electric charge from a cleaning target object. The cleaner 33 can include, for example, an irradiation device that irradiates the upper surface 11b of the mold 11 with ultraviolet light. The cleaner 33 can include, for example, an ionizer. The cleaner 33 can include, for example, an irradiation device that irradiates the upper surface 11b of the mold 11 with ultraviolet light and an ionizer. Alternatively, cleaning by the cleaner 33 can include at least one of wet cleaning, plasma cleaning, and vacuum suction. A target object to be cleaned by the cleaner 33 may include the mold holding surface of the mold holder 12 and the substrate holding surface of the substrate holder 2. The cleaner 33 can be placed at a third position P3 between the first position P1 and the second position P2.

The film forming apparatus 100 may include more cleaners and can include, for example, a second cleaner 36. The second cleaner 36 can be placed, for example, such that the first position P1 is located between the second cleaner 36 and the second position P2. The second cleaner 36 can include, for example, an ionizer. The second cleaner 36 can include, for example, an irradiation device that irradiates at least the mold holding surface of the mold holder 12 or the upper surface 11b of the mold 11 with ultraviolet light. Alternatively, the second cleaner 36 can include an irradiation device that irradiates the mold holding surface of the mold holder 12 with ultraviolet light. Alternatively, cleaning by the second cleaner 36 can include at least one of wet cleaning, plasma cleaning, and vacuum suction. A target object to be cleaned by the second cleaner 36 may include the substrate holding surface of the substrate holder 2.

The upper surface 11b of the mold 11 and the mold holding surface of the mold holder 12 can be regarded as regions in the film forming apparatus 100 in which foreign substances tend to occur due to the friction between the upper surface 11b of the mold 11 and the mold holding surface of the mold holder 12. In addition, the upper surface 11b of the mold 11 and the mold holding surface of the mold holder 12 are regions that tend to be charged by the friction described above, and foreign substance can be attracted to adhere to the upper surface 11b of the mold 11 and the mold holding surface of the mold holder 12 due to charging.

In a case where the curable composition CM is cured by applying the curing energy CE to the curable composition CM through the mold 11 while foreign substance adhere to the upper surface 11b of the mold 11, portions shadowed by foreign substances tend to undergo insufficient curing. In this case, the film formed of the cured product CP of the curable composition CM can have insufficient quality. In addition, insufficient curing causes the uncured curable composition CM to remain on the mold 11 side in a separation step and can cause a trouble in processing the next substrate 1.

In a case where the mold holder 12 holds the mold 11 while foreign substances adhere to the mold holding surface of the mold holder 12, the foreign substances are sandwiched between the mold holding surface of the mold holder 12 and the mold 11 and hence can exert influence on the shape of the lower surface 11a of the mold 11 (for example, can exert influence on the flatness of the lower surface 11a of the mold 11).

The controller 200 includes a processing device and a memory device such as a memory and controls the film forming apparatus 100 as a whole. The controller 200 is implemented by, for example, a programmable logic device (PLD) such as a field programmable gate array (FPGA). Alternatively, the controller 200 is implemented by a general-purpose or dedicated computer incorporating an application specific integrated circuit (ASIC) and programs. Furthermore, the controller 200 may be implemented by a combination of all or some of the above constituent elements. The controller 200 comprehensively controls the plurality of constituent elements of the film forming apparatus 100.

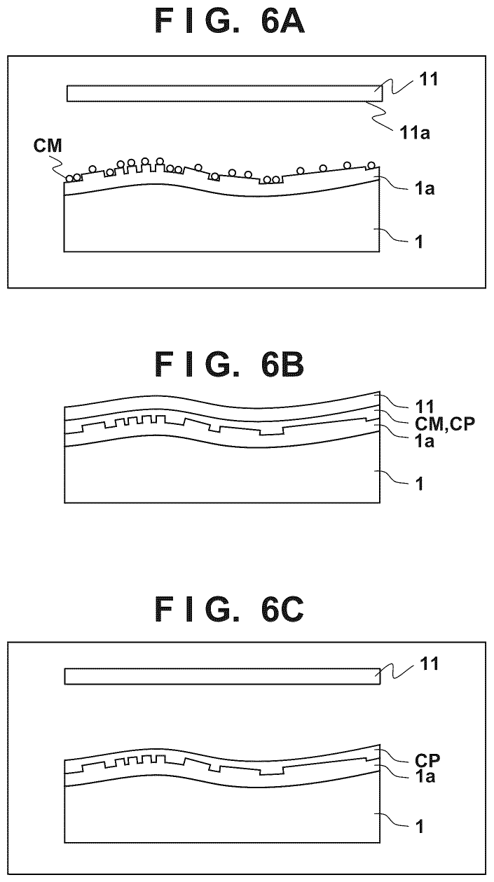

In order to facilitate the understanding of the operation of the film forming apparatus 100, a procedure for film forming processing by the film forming apparatus 100 will be schematically described with reference to FIGS. 6A to 6C. In the case described below, the substrate 1 has an underlying pattern 1a. As schematically shown in FIG. 6A, the dispenser 48 can apply or place a plurality of droplets of the curable composition CM on the substrate 1 (its underlying pattern 1a). As schematically shown in FIGS. 6A and 6B, the mold operating mechanism 30 brings the lower surface 11a of the mold 11 into contact with a plurality of droplets of the curable composition CM on the substrate 1 (its underlying pattern 1a). After the lapse of an appropriate period of time in this state, the space between the upper surface of the substrate 1 (its underlying pattern 1a) and the lower surface 11a of the mold 11 is filled with the curable composition CM to form a liquid film of the curable composition CM. Subsequently, as schematically shown in FIGS. 6B and 6C, the curing device 23 applies curing energy to the curable composition CM to form a film made of the cured product CP of the curable composition CM. The curing device 23 can apply curing energy to the curable composition CM through the mold 11. As schematically shown in FIG. 6C, the mold operating mechanism 30 then separates the mold 11 from the film made of the cured product CP of the curable composition CM.

A procedure for film forming processing by the second processing device 102 of the film forming apparatus 100 will be schematically described below with reference to FIGS. 1, 2, 3, 4, 5, and 7. The controller 200 controls this film forming processing. First of all, in step S701, a mold transfer mechanism (not shown) loads the mold 11 to the mold holder 12, and the mold holder 12 holds the mold 11, as shown in FIG. 1. In step S702, a substrate transfer mechanism (not shown) loads the substrate 1 coated with the curable composition CM by the first processing device 101 to the substrate holder 2 of the second processing device 102. As shown in FIG. 1, the substrate holder 2 then holds the substrate 1. In step S703, the mold operating mechanism 30 brings the curable composition CM on the substrate 1 into contact with the lower surface 11a of the mold 11 by lowering the mold 11 (contact step). This forms the multilayer structure ST composed of the curable composition CM and the mold 11.

In step S704, the mold holder 12 can cancel the holding of the mold 11. In step S705, the cleaner 33 can start to operate by being activated. Likewise, in step S705, the second cleaner 36 can start to operate by being activated. In step S706, the mold operating mechanism 30 raises the mold 11 to separate the mold holder 12 from the mold 11 placed on the substrate 1 through the curable composition CM. In this state, since the upper surface 11b of the mold 11 placed on the substrate 1 through the curable composition CM is exposed, the upper surface 11b of the mold 11 is cleaned by the cleaner 33 and the second cleaner 36.

Steps S703 and S706 can be understood as an operation step of separating the mold holder 12 from the mold 11 after forming the multilayer structure ST composed of the substrate 1, the curable composition CM, and the mold 11 by placing the mold 11 held by the mold holder 12 on the curable composition on the substrate 1. Step S708 can be understood as a curing step of curing the curable composition CM by applying the curing energy CE to the curable composition CM of the multilayer structure ST after the operation step. Step S712 can be understood as a separation step of separating the mold 11 from the multilayer structure ST after the curing step. A period after step S705 and before step S711 can be understood as a cleaning step of cleaning the upper surface 11b of the mold 11 after step S706 (operation step) and before step S712 (separation step).

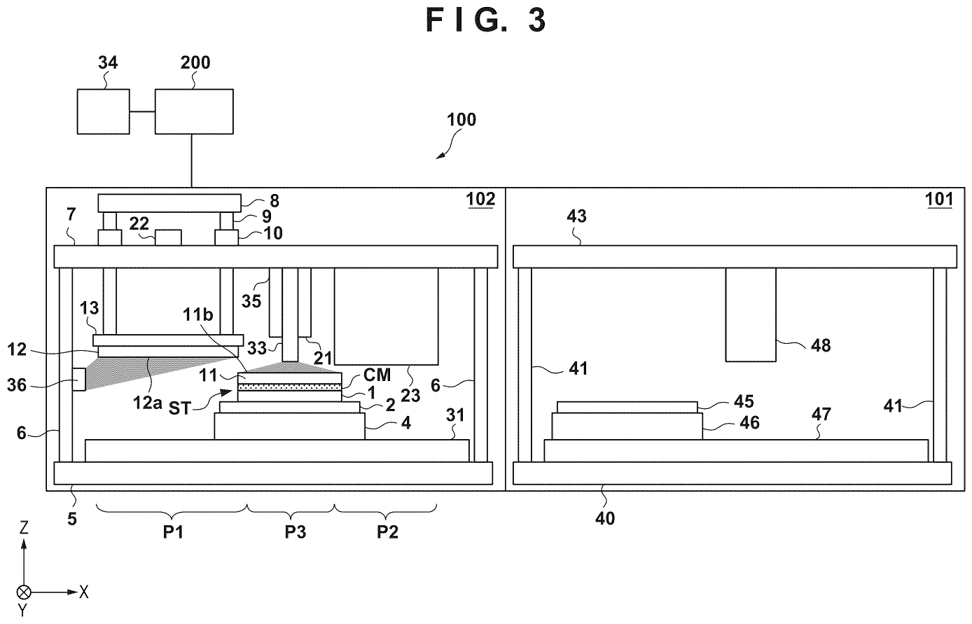

As shown in FIG. 3, in step S707, the substrate driving mechanism 31 moves the substrate stage 4 from the first position P1 to the second position P2 through the third position P3. This also moves the multilayer structure ST held by the substrate holder 2 mounted on the substrate stage 4 from the first position P1 to the second position P2 through the third position P3. The cleaner 33 is placed at the third position P3 and can clean the upper surface of the multilayer structure ST, that is, the upper surface 11b of the mold 11 when the multilayer structure ST held by the substrate holder 2 mounted on the substrate stage 4 moves from the first position P1 to the second position P2 through the third position P3. The second cleaner 36 may be placed so as to clean the mold holding surface (lower surface) of the mold holder 12 and can clean the mold holding surface (lower surface) of the mold holder 12 which is exposed to the lower space.

The substrate driving mechanism 31 can drive the substrate holder 2 so as to temporarily stop at the third position P3 when moving from the first position P1 to the second position P2. This makes it possible to improve the efficiency of the cleaning of the upper surface 11b of the mold 11 held by the substrate holder 2. Alternatively, the substrate holder 2 may continuously move from the first position P1 to the second position P2. This is advantageous in improving the throughput of processing on the substrate 1. The region that can be cleaned by the cleaner 33 is preferably larger than the mold 11. In continuously moving the substrate holder 2 from the first position P1 to the second position P2, the driving speed of the substrate holder 2 by the substrate driving mechanism 31 can be set to, for example, 500 mm/sec or more and 1,000 mm/sec or less. If the cleaner 33 is implemented by an ionizer, the distance between the ionizer and the multilayer structure ST may be set to, for example, 10 mm or more and 300 mm or less, and the irradiation angle may be set to 150° or more.

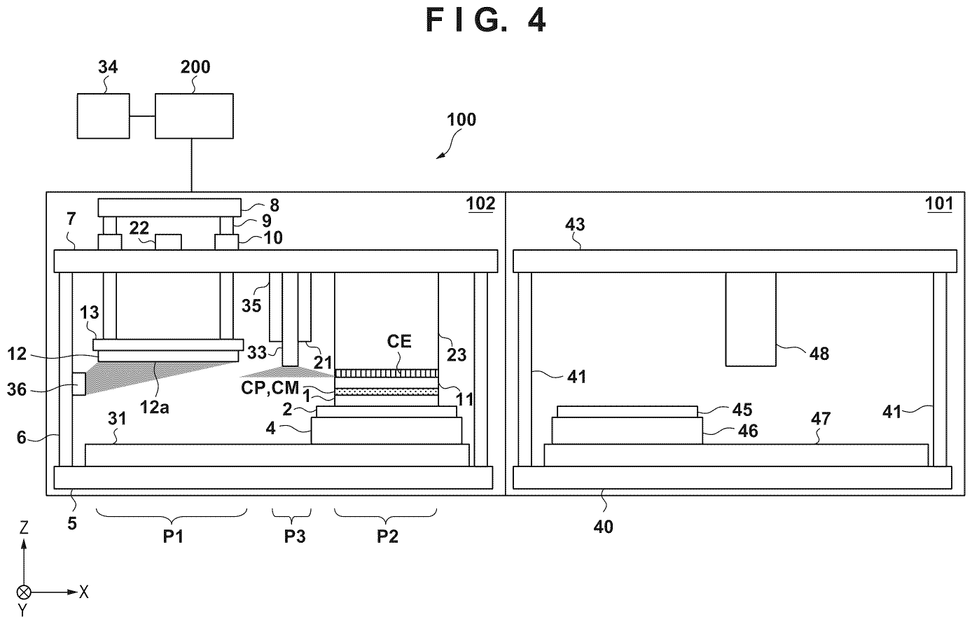

In step S708, as shown in FIG. 4, the curing device 23 cures the curable composition CM by applying the curing energy CE to the curable composition CM of the multilayer structure ST located at the second position P2 through the mold 11 (curing step). This forms a film made of the cured product CP of the curable composition CM.

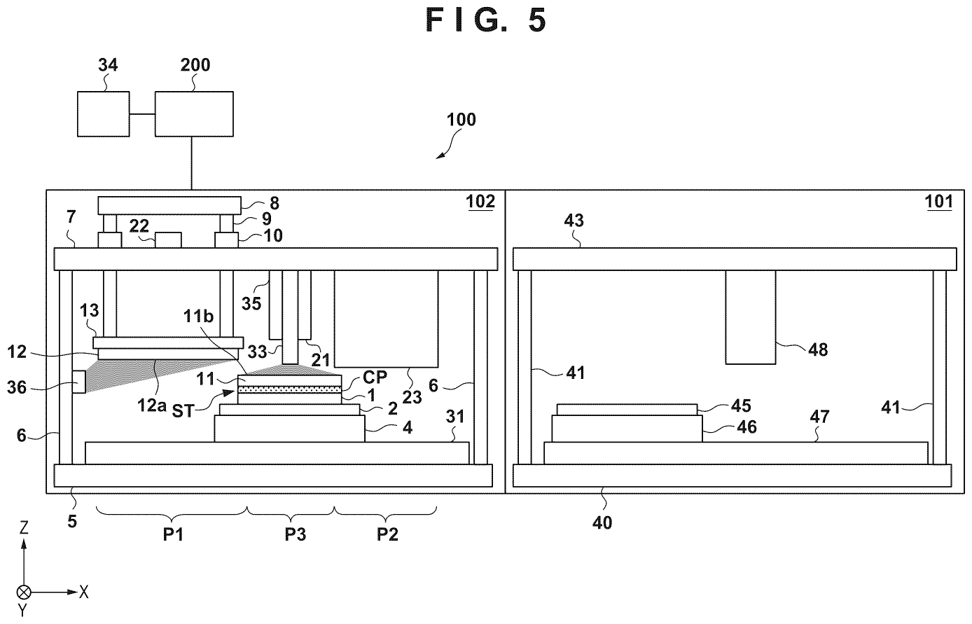

In step S709, as shown in FIG. 5, the substrate driving mechanism 31 moves the substrate stage 4 from the second position P2 to the first position P1 through the third position P3. This also moves the multilayer structure ST held by the substrate holder 2 mounted on the substrate stage 4 from the second position P2 to the first position P1 through the third position P3. The cleaner 33 may be placed at the third position P3. In this case, the upper surface of the multilayer structure ST, that is, the upper surface 11b of the mold 11 is also cleaned when the multilayer structure ST held by the substrate holder 2 mounted on the substrate stage 4 moves from the first position P1 to the second position P2 through the third position P3.

The substrate driving mechanism 31 can drive the substrate holder 2 so as to temporarily stop at the third position P3 when moving from the second position P2 to the first position P1. This makes it possible to improve the efficiency of the cleaning of the upper surface 11b of the mold 11 held by the substrate holder 2. Alternatively, the substrate holder 2 may continuously move from the second position P2 to the first position P1. This is advantageous in improving the throughput of processing on the substrate 1.

In step S710, the mold operating mechanism 30 lowers the mold holder 12 to bring the mold 11 of the multilayer structure ST into contact with the mold holder 12. The mold holder 12 then holds the mold 11. In step S711, the cleaner 33 can stop operating by being inactivated. Likewise, in step S711, the second cleaner 36 can stop operating by being inactivated. In step S712, the mold operating mechanism 30 raises the mold 11 to separate the mold 11 from the multilayer structure ST (the film made of the cured product CP of the curable composition CM on the substrate 1) (separation step).

In step S713, the substrate 1 is unloaded from the substrate holder 2. In step S714, it is determined whether there is any substrate 1 to be processed next. If there is any substrate 1 to be processed next, steps S702 to S713 are executed for the substrate 1. In contrast to this, if there is not any substrate 1 to be processed next, the mold 11 is unloaded from the mold holder 12 in step S715.

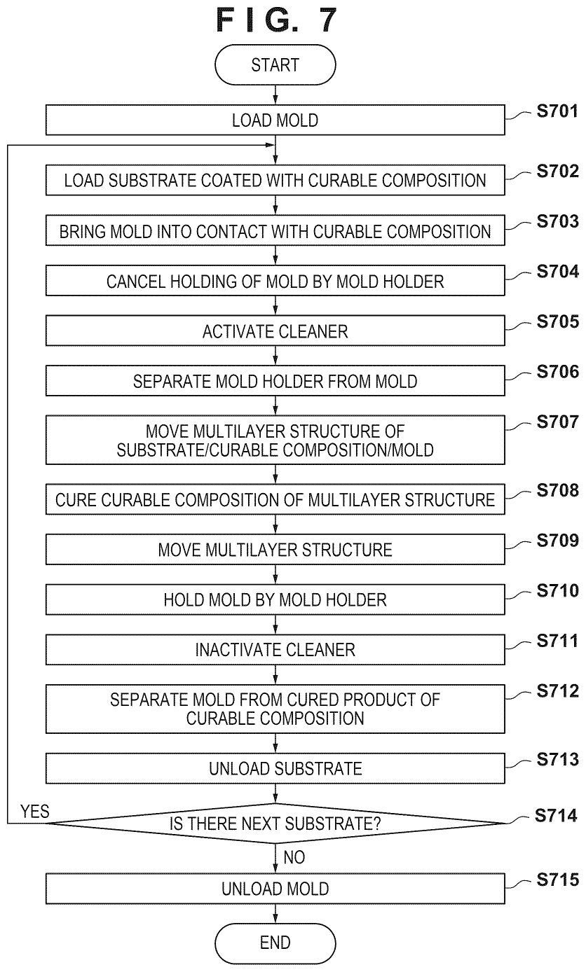

In the case shown in FIG. 7, the cleaner 33 is activated between step S704 and step S706 and is inactivated between step S710 and step S712. However, the cleaner 33 may be activated in the interval from when the mold 11 is placed on the curable composition on the substrate 1 at the first position P1 to when the multilayer structure moves from the second position P2 to the first position P1. In addition, the cleaner 33 may be inactivated in the interval from when the substrate holder 2 moves from the second position P2 to the first position P1 to when the new substrate 1 is placed on the substrate holder 2 in place of the substrate 1 is held by the substrate holder 2. The second cleaner 36 may be activated in the interval from when the mold 11 is placed on the curable composition CM on the substrate 1 at the first position P1 to when the multilayer structure ST moves from the second position P2 to the first position P1. In contrast, the second cleaner 36 may be inactivated in the interval from when the substrate holder 2 moves from the second position P2 to the first position P1 to when the new substrate 1 is placed on the substrate holder 2 in place of the substrate 1 held by the substrate holder 2.

Although the cleaner 33 may be activated continuously in the processing of forming cured films on the plurality of substrates 1, the cleaner 33 may be repeatedly activated and inactivated in the above manner. This makes it possible to reduce the power consumption and prolong the service life of the cleaner 33. Likewise, although the second cleaner 36 may be activated continuously in the processing of forming cured films on the plurality of substrates 1, the second cleaner 36 may be repeatedly activated and inactivated in the above manner. This makes it possible to reduce the power consumption and prolong the service life of the second cleaner 36.

An article manufacturing method of manufacturing an article by using the film forming apparatus 100 will be described below. The article manufacturing method can include a film forming step of forming a film on the substrate 1 by using the film forming apparatus 100 and a processing step of obtaining an article by processing the substrate 1 having undergone the film forming step. The processing step can include, for example, a photolithography step, an etching step, another film forming step, a dicing step, and a sealing step.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-201759, filed Nov. 19, 2024, which is hereby incorporated by reference herein in its entirety.

What is claimed is:

1. A film forming apparatus that forms a film by bringing a curable composition on a substrate and a mold into contact with each other and curing the curable composition, the apparatus comprising:
a substrate holder configured to hold the substrate;
a mold operating mechanism that includes a mold holder configured to hold the mold and is configured to place the mold on a curable composition on the substrate; and
a cleaner configured to clean an upper surface of the mold while the mold is placed on the curable composition on the substrate and the mold holder is separated from the mold.

2. The apparatus according to claim 1, further comprising a curing device configured to cure the curable composition by applying curing energy to the curable composition of a multilayer structure composed of the substrate, the curable composition, and the mold.

3. The apparatus according to claim 2, wherein the curing device is placed at a second position spaced apart from a first position at which the mold operating mechanism is placed, and
the substrate holder is configured to move between a plurality of positions including the first position and the second position.

4. The apparatus according to claim 3, wherein the mold operating mechanism operates the mold so as to separate the mold from the multilayer structure held by the substrate holder that has moved from the second position to the first position.

5. The apparatus according to claim 4, wherein the cleaner is placed at a third position between the first position and the second position.

6. The apparatus according to claim 5, wherein the cleaner includes an irradiation device configured to irradiate the upper surface with ultraviolet light.

7. The apparatus according to claim 6, wherein the cleaner further includes an ionizer.

8. The apparatus according to claim 6, wherein the cleaner is activated in an interval from when the mold is placed on the curable composition on the substrate at the first position to when the multilayer structure moves from the second position to the first position.

9. The apparatus according to claim 8, wherein the cleaner is inactivated in an interval from when the substrate holder moves from the second position to the first position to when a new substrate is placed on the substrate holder in place of the substrate held by the substrate holder.

10. The apparatus according to claim 7, wherein the cleaner is activated in an interval from when the mold is placed on the curable composition on the substrate at the first position to when the multilayer structure moves from the second position to the first position.

11. The apparatus according to claim 10, wherein the cleaner is inactivated in an interval from when the substrate holder moves from the second position to the first position to when a new substrate is placed on the substrate holder in place of the substrate held by the substrate holder.

12. The apparatus according to claim 5, wherein a region that is configured to be cleaned by the cleaner is larger than the mold.

13. The apparatus according to claim 12, wherein the substrate holder temporarily stops at the third position when moving from the first position to the second position.

14. The apparatus according to claim 12, wherein the substrate holder continuously moves from the first position to the second position.

15. The apparatus according to claim 12, wherein the substrate holder temporarily stops at the third position when moving from the second position to the first position.

16. The apparatus according to claim 12, wherein the substrate holder continuously moves from the second position to the first position.

17. The apparatus according to claim 3, further comprising a second cleaner configured to clean the substrate holder and the mold holder,
wherein the first position is located between the second cleaner and the second position.

18. The apparatus according to claim 17, wherein the second cleaner includes an ionizer.

19. An article manufacturing method comprising:
forming a film on a substrate by using a film forming apparatus by bringing a curable composition on the substrate and a mold into contact with each other and curing the curable composition; and
obtaining an article by processing the substrate having undergone the forming,
wherein the film forming apparatus comprises:
a substrate holder configured to hold the substrate;
a mold operating mechanism that includes a mold holder configured to hold the mold and is configured to place the mold on a curable composition on the substrate; and
a cleaner configured to clean an upper surface of the mold while the mold is placed on the curable composition on the substrate and the mold holder is separated from the mold.

20. A film forming method of forming a film by bringing a curable composition on a substrate and a mold into contact with each other and curing the curable composition, the method comprising:
separating a mold holder from a mold after forming a multilayer structure composed of a substrate, a curable composition, and the mold by placing the mold held by the mold holder on the curable composition on the substrate;
curing the curable composition by applying curing energy to the curable composition of the multilayer structure after the separating the mold holder;
separating the mold from the multilayer structure after the curing; and
cleaning an upper surface of the mold after the separating the mold holder and before the separating the mold.
